(19) United States
(12) Patent Application Publication
(10) Pub. No.: US 2006/0224445 A1
(43) Pub. Date: Oct. 5, 2006

(54) Adjusting an advertising cost, such as a per-ad impression cost, using a likelihood that the ad will be sensed or perceived by users

(76) Inventors: Brian Axe, San Francisco, CA (US); Gregory Joseph Badros, Mountain View, CA (US); Rama Ranganath, Mountain View, CA (US)

Correspondence Address: STRAUB & POKOTYLO, 620 TINTON AVENUE, BLDG. B, 2ND FLOOR, TINTON FALLS, NJ, 07724, US

(21) Appl. No.: 11/093,753

(22) Filed: Mar. 30, 2005

(51) Int. Cl. G06Q 30/00; G06F 17/00

(52) U.S. Cl. 705/14; 705/400

(57) ABSTRACT

A price paid for an ad impression may be adjusted using an estimated probability that the ad will be viewed, or otherwise perceived or sensed, or using one or more factors which may be used to estimate such a probability. The price and/or probability may be adjusted using events occurring after the impression of the ad.

### § 1. BACKGROUND OF THE INVENTION

§ 1.1 Field of the Invention

The present invention concerns advertising, such as online advertising. In particular, the present invention concerns improving how advertising costs, such as per-ad impression costs for example, are determined.

§ 1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.). Query keyword targeting has been used by search engines to deliver relevant ads. For example, the AdWords advertising system by Google of Mountain View, Calif., delivers ads targeted to keywords from search queries. Similarly, content targeted ad delivery systems have been proposed. For example, U.S. patent application Ser. No. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and Ser. No. 10/375,900 (incorporated by reference and referred to as “the '900 application”) titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example. Content targeted ad delivery systems, such as the AdSense advertising system by Google for example, have been used to serve ads on Web pages.

As can be appreciated from the foregoing, serving ads relevant to concepts of text in a text document and serving ads relevant to keywords in a search query are useful because such ads presumably concern a current user interest. Consequently, such online advertising has become increasingly popular. Moreover, advertising using other targeting techniques, and even untargeted online advertising, has become increasingly popular. However, such advertising systems still have room for improvement.

For example, human judgment is often used to determine the price paid for pay-per-impression ads (e.g., often based on the type of audience attracted to a Website as well and the likelihood that the ad will reach its intended audience). Generally, ad impressions commanding the highest price have been those thought to have a high likelihood of being seen by the audience targeted by the advertiser. As an example, many contracts between advertisers and Web publishers require ads to be “above the fold” or on the screen seen by users with computers set to standard screen sizes (e.g. 640×690 or 800×600, etc). More specifically, ad systems for large publishers typically define advertiser “channels” which are either (A) high price “above the fold” inventory, or (B) lower price “run of site” inventory. The “run of site” inventory is either “below the fold” or on Web pages where the user is likely not to interact with an ad (e.g., a Website login page). Often, when advertisers buy ad placements from large publishers, they are shown the places their ads will run and a direct sales force negotiates a price based on the inventory viewed. The current state of the art requires a person on behalf of the Web publisher to classify the placements into “good” vs. “ok” channels, and a person on behalf of the advertiser to judge and negotiate a price. Thus, advertisers may have to negotiate and specify different prices for different channels.

The foregoing customs of pay-per-impression advertising have a number of disadvantages. First, due to the simplification of defining two broad channels or classes of ad placements (e.g., “good” and “ok”), parts of the “good” inventory may also include some “ok” placements and vice-versa. Second, to be diligent, the advertiser must review each Website and go through laborious negotiations for each Website, and possibly each placement, to set the price to be paid for ad impressions. This human involvement and per channel pricing does not scale to allow purchase—on a price per impression basis—of ad spots displayed on a large network of Websites (e.g., 1,000+ to 2,000+ sites—some current average-sized networks have 100-200 Websites).

To avoid the scalability problem, many large networks sell ads on a price-per-click basis. Unfortunately, however, price-per-click advertising does not serve the needs of so-called “brand” advertisers, who may just want to get a message across without requiring a click (e.g. “Watch Alias. Now on Wed. nights on ABC”, or “Diet Pepsi—Light! Crisp! Refreshing!”).

In view of the foregoing problems with existing advertising practices, and in particular, with pay-per-impression advertising practices, it would be useful to improve advertising, such as pay-per-impression advertising.

### § 2. SUMMARY OF THE INVENTION

Embodiments consistent with the present invention may adjust a price for an ad impression using a probability that the ad will be viewed or otherwise sensed or perceived, or using one or more factors on which such a probability may be based. The price, probability, and/or factor(s) may be adjusted using events occurring after the impression of the ad.

### § 3. BRIEF DESCRIPTION OF THE DRAWINGS

FIG. 1 is a diagram showing parties or entities that can interact with an advertising system.

FIG. 2 is a diagram illustrating an environment in which, or with which, embodiments consistent with the present invention may operate.

FIG. 3 is a bubble diagram of exemplary operations that may be performed in a manner consistent with the present invention, as well as information that may be used and/or generated by such operations.

FIG. 4 is a flow diagram of an exemplary method for determining an estimate of a relative value of an ad impression and adjusting the costs of the ad impression accordingly, in a manner consistent with the present invention.

FIG. 5 is a flow diagram of an exemplary method for determining at least one factor on which a relative value of an ad impression may be based and adjusting the costs of the ad impression accordingly, in a manner consistent with the present invention

FIG. 6 is a block diagram of apparatus that may be used to perform at least some operations, and store at least some information, in a manner consistent with the present invention.

FIGS. 7A-7C illustrate how the per-impression costs of three ads served on a Web page can be adjusted using an exemplary method consistent with the present invention.

### § 4. DETAILED DESCRIPTION

The present invention may involve novel methods, apparatus, message formats, and/or data structures for improving how advertising costs, such as per-impression ad costs, are determined. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention to include any patentable subject matter described.

In the following definitions of terms that may be used in the specification are provided in § 4.1. Then, environments in which, or with which, the present invention may operate are described in § 4.2. Exemplary embodiments of the present invention are described in § 4.3. Thereafter, a specific example illustrating the usefulness of one exemplary embodiment of the present invention is provided in § 4.4. Finally, some conclusions regarding the present invention are set forth in § 4.5.

### § 4.1 DEFINITIONS

Online ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, user device characteristics, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document being served includes certain topics or concepts, or falls under a particular cluster or clusters, or some other classification or classifications. In some systems, an advertiser may specify that its ad is to be served only to (or is not to be served to) user devices having certain characteristics. Finally, in some systems an ad might be targeted so that it is served in response to a request sourced from a particular location, or in response to a request concerning a particular location.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) is referred to as the “conversion rate.” If a conversion is defined to be able to occur within a predetermined time since the serving of an ad, one possible definition of the conversion rate might only consider ads that have been served more than the predetermined time in the past.

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has an addressable storage location and can therefore be uniquely identified by this addressable location. A universal resource locator (URL) is an address used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer, Netscape, Opera, Firefox, etc.), a media player (e.g., an MP3 player, a Realnetworks streaming audio file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary. A “Web publisher” is an example of a content owner.

“Sensing” can mean either of, or both of, receiving information below a threshold of conscious perception (“subliminal”) and being aware of received information (“perceive”).

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

### § 4.2 Exemplary Advertising Environments in which, or with which, the Present Invention may Operate

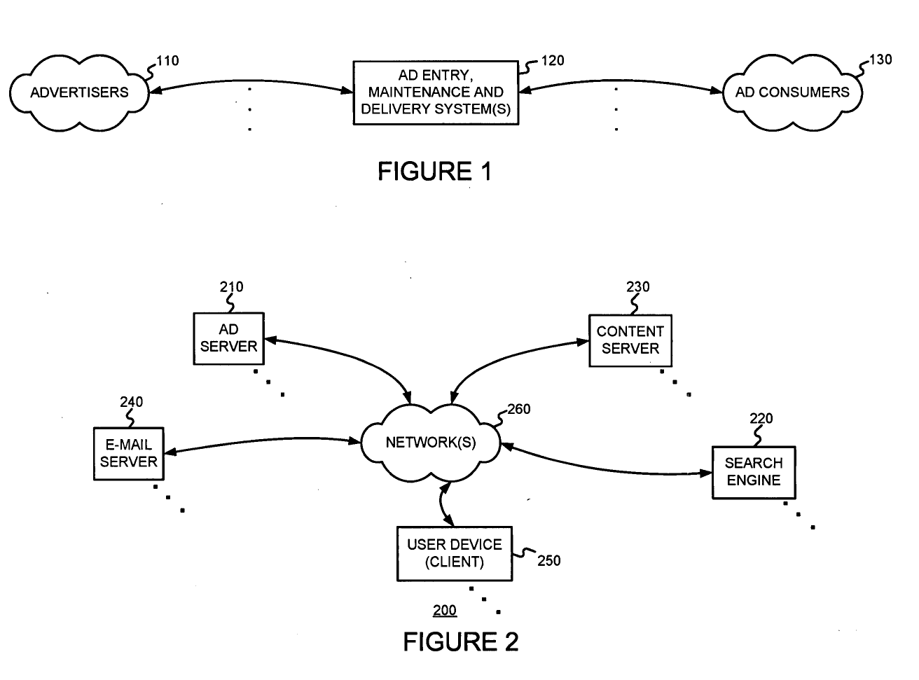

FIG. 1 is a high-level diagram of an advertising environment. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or selection related to the ad occurred) to the system 120. This usage information may include measured or observed user behavior related to ads that have been served.

The ad server 120 may be similar to the one described in the '900 application. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, etc.), and price information (e.g., cost, average cost, or maximum cost (per impression, per selection, per conversion, etc.)). Therefore, a single cost, a single maximum cost, and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or server). Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer browser from Microsoft, the Opera Web Browser from Opera Software of Norway, the Navigator browser from AOL/Time Warner, the Firefox browser from Mozilla, etc.), an e-mail facility (e.g., Outlook from Microsoft), etc. A search engine 220 may permit user devices 250 to search collections of documents (e.g., Web pages). A content server 210 may permit user devices 250 to access documents. An e-mail server (such as GMail from Google, Hotmail from Microsoft Network, Yahoo Mail, etc.) 240 may be used to provide e-mail functionality to user devices 250. An ad server 210 may be used to serve ads to user devices 250. The ads may be served in association with search results provided by the search engine 220. However, content-relevant ads may be served in association with content provided by the content server 230, and/or e-mail supported by the e-mail server 240 and/or user device e-mail facilities.

As discussed in the '900 application, ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, etc.) back to the ad server 120/210. Alternatively, or in addition, such information may be provided back to the ad server 120/210 by some other means.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where, and/or how the ad was to be rendered (e.g., position, selection or not, impression time, impression date, size, conversion or not, etc.) back to the ad server 120/210. Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under over, or otherwise in association with an e-mail.

Although the foregoing examples described servers as (i) requesting ads, and (ii) combining them with content, one or both of these operations may be performed by a client device (such as an end user computer for example).

### § 4.3 Exemplary Embodiments

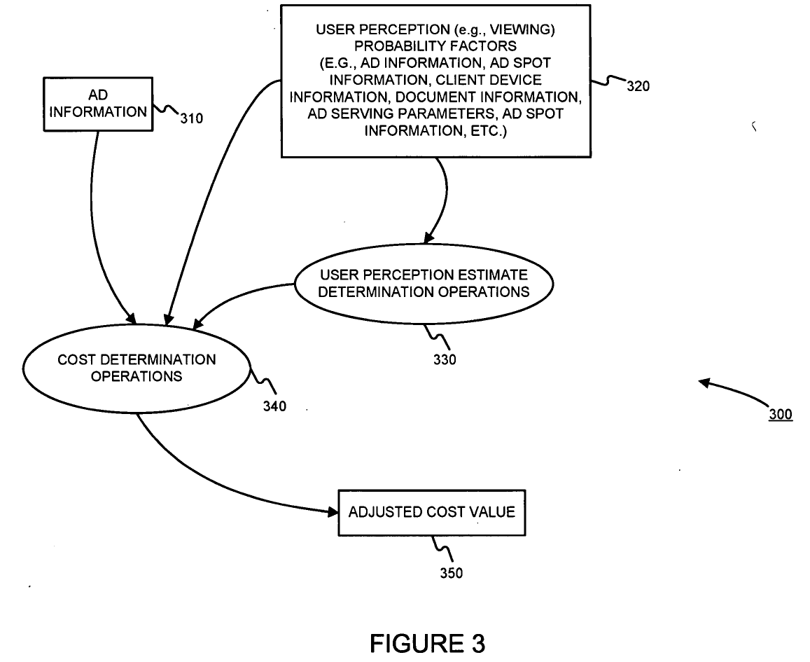

FIG. 3 is a bubble diagram of exemplary operations for adjusting ad costs which may be performed in a manner consistent with the present invention, as well as information that may be used and/or generated by such operations. Cost determination operations 340 may be used to determine or adjust prices 350 to be paid for ad impressions using (a) user perception probability factors 320, and/or (b) a user perception estimate (i.e., some indication of the likelihood the ad(s) will be viewed or otherwise perceived by a user) generated by user perception estimate determination operations 330. For example, since an ad served in an ad spot at the top portion of a Web page is more likely to be viewed by a user, its impression might be worth more to an advertiser than that of an ad served in an ad spot at the bottom of a Web page, especially if the bottom of the Web page is not initially visible and can only be seen if a user scrolls down. As another example, since an ad served in an ad spot that occludes (at least temporarily) content on the Web page is more likely to be viewed by a user, its impression might be worth more to an advertiser than that of an ad served in an ad spot spaced from the main content of the Web page. As yet another example, since users are more likely to scroll down to the bottom of a product review Web page than a blog Web page, an ad served in an ad spot at the bottom portion of a product review Web page is more likely to be viewed by a user, than an ad served in an ad spot at the bottom of a blog Web page. Accordingly, an ad impression at the bottom of a product review Web page might be worth more to an advertiser than an ad impression at the bottom of a blog Web page.

The cost adjustment may be made using a user perception estimate, or using one or more factors 320 which may be used in determining such an estimate. The factors may include one or more of ad information (e.g., the type of ad such as text-only, animation, audio, video, image, etc., the size of the ad, the font size of the ad, colors of the ad, etc.), client device information (e.g., browser type and version, display size, display resolution, speaker volume, mute on/off, user input means, etc.), document information (e.g., document type, document size, document age, proportion of ad spots space to content space, user dwell times, etc.), ad serving parameters, ad spot information (e.g., absolute and/or relative position of ad spot, per-spot selection rates, per-spot mouse-overs, per-spot hovers, proximity of ad spot to document content, occlusion of document content by ad spot, obscuring of document content by ad spot, ad spot adjacent to content, ad spot separated from content, ad spot embedded within (e.g., surrounded by) content, ad spot partially or totally occluding or obscuring content (or other ads), ad spot partially or totally occluded or obscured by content (or other ads), etc.), end user information (e.g., user hover information, user ad click information, user dwell time information, user scroll information, user eye movement information, etc.), survey data, focus group data, view-through data (e.g., determined using cookies if someone to which an ad was rendered later visited the Website or Webpage mentioned in the ad), etc. Thus, user perception probability factors 320 may include information providing some indication that the ad(s) will be perceived (e.g., viewed) by users.

The user perception probability factors may be tracked, stored, and/or applied on a per user, per user type, per document, per document type, per ad (or ad spot), and/or per ad (or ad spot) type basis.

Ad information 310 may include one or more of offer information (e.g., price, average price, or maximum price (e.g., per impression, selection, or conversion), targeting information, performance information (e.g., selection rate, conversion rate, etc.), etc.

User perception estimate determination operations 330 may obtain information from the user perception probability factors 320 and use it to determine an estimate of a relative value of an ad impression based on the likelihood (i.e., probability) that the ad will be viewed, perceived, or otherwise sensed, by a user. Such an estimate may be made available to the cost determination operations 340, which may use the estimate to adjust ad impressions prices 350. Alternatively, or in addition, the cost determination operations 340 may use one or more of the user perception probability factors 320 to adjust the price.

### § 4.3.1 Exemplary Methods

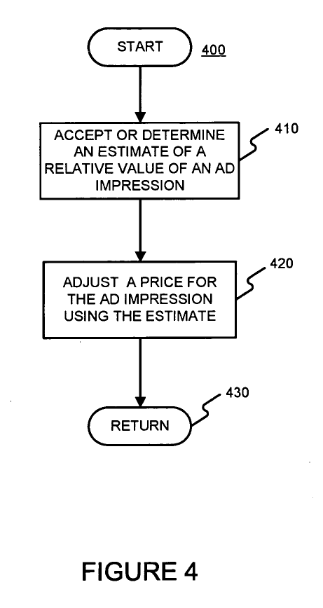

FIG. 4 is a flow diagram of an exemplary method 400 for determining an estimate of a relative value of an ad impression and adjusting the costs of the ad impression accordingly, in a manner consistent with the present invention.

Specifically, the method 400 may determine or accept an estimate of a relative value of an ad impression. (Block 410) Once the estimate has been determined or accepted, the method 400 may adjust a price for the ad impression using the estimate (Block 420) before the method 400 is left (Node 430). Therefore, the method 400 allows prices charged for ad impressions to be adjusted (e.g., increased and/or decreased) according to their estimated relative value (e.g., a probability of being viewed or perceived by users). This can be used to relieve an advertiser of the need to specify different per-impression prices for different ad spots (or different channels).

Referring back to block 410, the act of determining an estimate (relative) value of an ad impression may include estimating whether or not the ad will be viewed or perceived. As discussed in § 4.3 above, the act of determining whether the ad will be viewed or perceived may depend on a number of factors. In particular, some of these factors may include: a location of the ad impression on a Web page, whether or not the ad will be rendered on an initial visible portion of a Web page, a likelihood of browser scrolling, (which may depend on a browser type on which the ad is to be rendered, user scroll history, and/or document scroll history), etc.

Referring back to block 420, the method 400 may adjust a price to be paid for the ad impression using the determined estimate of (relative) value of an ad impression. As understood from the aforementioned, the adjusted price may be correlated with a likelihood the ad will be viewed or perceived. For example, eye-catching ads rendered on an initially visible portion of a Web page may be priced at full cost, whereas dull ads rendered on a portion of the Web page not initially visible (e.g., visible only if the user scrolls down) may be priced at a discount to full cost.

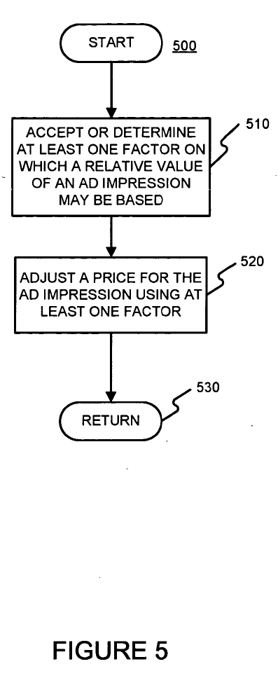

FIG. 5 is a flow diagram of an exemplary method 500 that may be used to adjust the costs of the ad impression using at least one user perception probability factor, in a manner consistent with the present invention.

Specifically, the method 500 may accept or determine at least one factor on which a relative value of an ad impression may be based. (Block 510) The method 500 may then adjust a price for the ad impression using the factor(s) (Block 520) before the method 500 is left (Node 530). Therefore, the method 500 allows an advertising system to adjust the prices charged for ad impressions using one or more factors that influence the relative value of an ad impression. This can be used to relieve an advertiser of the need to specify different per-impression prices for different ad spots (or different channels).

Referring back to block 510, factors that influence whether an ad will be viewed/perceived or not may include those discussed in § 4.3 above with reference to FIG. 3. These factors may be determined in various ways.

Referring back to block 520, the method 500 may adjust a price to be paid for the ad impression using the factor(s) accepted or determined in block 510. Again, as understood from the aforementioned, the adjusted price may be correlated with a factor indicative of the likelihood the ad will be viewed or perceived. For example, eye-catching ads rendered on an initially visible portion of a Web page may be priced at full cost, whereas dull ads rendered on a portion of the Web page not initially visible (e.g., visible only if the user scrolls down) may be priced at a discount to full cost.

### § 4.3.2 Exemplary Apparatus

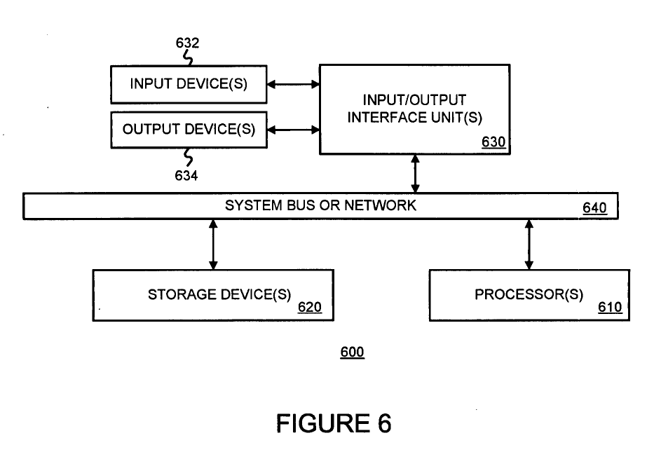

FIG. 6 is high-level block diagram of a machine 600 that may perform one or more of the operations discussed above. The machine 600 basically includes one or more processors 610, one or more input/output interface units 630, one or more storage devices 620, and one or more system buses and/or networks 640 for facilitating the communication of information among the coupled elements. One or more input devices 632 and one or more output devices 634 may be coupled with the one or more input/output interfaces 630.

The one or more processors 610 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. At least a portion of the machine executable instructions may be stored (temporarily or more permanently) on the one or more storage devices 620 and/or may be received from an external source via one or more input interface units 630.

In one embodiment, the machine 600 may be one or more conventional personal computers. In this case, the processing units 610 may be one or more microprocessors. The bus 640 may include a system bus. The storage devices 620 may include system memory, such as read only memory (ROM) and/or random access memory (RAM). The storage devices 620 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 632, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 610 through an appropriate interface 630 coupled to the system bus 640. The output devices 634 may include a monitor or other type of display device, which may also be connected to the system bus 640 via an appropriate interface. In addition to (or instead of) the monitor, the personal computer may include other (peripheral) output devices (not shown), such as speakers and printers for example.

Referring back to FIG. 2, one or more machines 600 may be used as end user client devices 250, content servers 230, search engines 220, email servers 240, and/or ad servers 210.

### § 4.3.3 Refinements and Alternatives

The system may also use human defined data to help determine an adjusted cost paid for an ad impression. For instance, the system may use data defined by humans that may characterize Websites and ad placements where eye-catching ads have high user interaction as “premium” and Websites and ad placements where dull ads have low user interaction as “run of site”. For example, humans may define that all “premium” placements are not on login or chat pages. In such a case, ads rendered on login or chat pages would not be charged full price as in “premium” placements.

User perception probability factors may be determined from actual information associated with the impression, historical information, studies (e.g., market share, user interactions, etc.), and/or survey information, etc. Thus, for example, client device information may concern the actual device to which the particular ad will be served (e.g., 21 inch monitor with 768×1024 pixel resolution, running version 4.0 of the Microsoft Explorer browser), or client devices from survey or historical information (e.g., 50% likely a 15 inch monitor, 20% likely a 17 inch monitor, 16% likely a 19 inch monitor, . . . , 85% likely Explorer browser, 8% likely Netscape browser, 5% likely Firefox browser, . . . , particular (type of) Web page scrolled down to bottom 78% of the time, . . . , etc.). As another example, a relative ad (spot) location may be determined by a server application. For example, a server may render a Web page in accordance with the rendering engine of the most popular Web browsers and for a variety of screen settings, and determine if an ad is displayed within the initial on-screen portion of the Web page (user doesn't need to scroll down) for various combinations of browsers and screen settings (e.g., Internet Explorer and 800×600). Market data on browser share and screen settings could be used to determine a percentage of times an ad is within the initial viewing portion of a Web page for a typical (or a given type of) end user. Such a percentage may be used as a user perception probability factor.

In at least some embodiments consistent with the present invention, Java code for requesting an I-frame (See, e.g., the '900 application.) may be used to determine the location of an ad (or ad spot) on a Web page.

Web page type (e.g., publisher format and subject matter) may also be useful. For example, various Web pages or publishers may use different formats, at least some of which may have rather predictable user interaction models. These formats may be detected and the interaction models may be used to determine the likelihood the ad impression will be perceived by an end user. For example, it might be very unlikely that ad spots at the bottom of a blog Web page will be seen or otherwise perceived by a user. On the other hand, it might be more likely that ad spots at the bottom of a product review Web page will be seen or otherwise perceived by a user. As another example, ads rendered at the bottom of a news Web page (e.g., NY Times) may be seen by all users who read the entire article. However, since not all users read the entire article, the system may use collected survey or behavior data to estimate what percentage of users read articles to the end of the Web page. Therefore, the system may determine the likelihood ads will be seen by an end user using Web page types and user interaction models. This, in turn, can be used to estimate of a relative value of an ad impression for various Web page types.

Examples of document (e.g., Web page) types, on which user interaction can be modeled, include business-to-business (B2B) & Specialized Industries, business-to-consumer (B2C) & Online Retailers, Blogs & Journals, Browsers & Media Players, Chats & Forums, City Guides & Local Information, Classifieds & Listings, Directories & Reference, Domain Channel, Download & Link Collections, Enthusiast Sites & Topical Communities, Expert Sites, FAQs & Technical Information, Games & Interactive, Home & Landing Pages, Image Collections, Login & Site Information (publisher quality), News Content, Niche & Vertical Portals, Online Magazines, Other, Personal Pages, Portals & ISPs, Product Reviews & Consumer Information, Rich Media (Audio/Video), Search, Social Networks, and Spam.

Furthermore, collecting scroll data from a sample of users using a special browser or javascript may also help determine the likelihood an ad will be seen by an end user. A specific Web page may be characterized by the interaction with the Web page by this sample of users. Alternatively, or in addition, a certain Web page type may be characterized by the interaction with Web pages of a common format by this sample of users. Alternatively, or in addition, one or more other groupings of Web pages (e.g., by domain, by content author, by content topic, etc.) may be characterized by the interaction with such a collection by this sample of users. The scroll data may include information concerning how often and how much a Web page is scrolled up and down per Web site (or per Web site format or type, or per Web site group, etc.), or per user. Hence, the server may use such scroll data to help determine a likelihood that an ad in an ad spot (e.g., an ad spot that is not initially visible) may be seen for given end user, and/or a given Web page.

History of selections (e.g., clicks) may also be used. For example, click data from individual ad units may be collected to determine the likelihood the ad is seen by an end user since it may be inferred that an ad with a high selection rate was seen by the users that clicked it. The collected historical data may also be normalized depending on a number of categories such as, the type of ad shown, the subject matter of the ads and the Web page, the Web page or Website format (e.g., ads on a login page generally do not get selected, but are likely seen if displayed within the viewing portion of the Website on the screen.), etc. For a given Web page, there might not be enough selection data to determine a reliable result. Thus, the selection history data from similar Web pages could be aggregated to determine a prediction for a given Web page similar to (or belonging to) the set of Web pages characterized. As an extension to the above concept, the likelihood that an ad is seen by a particular target audience (e.g., teenagers who play video games) can also be determined. This likelihood may be taken into account, along with the likelihood the ad is seen by an end user, when determining an estimated value paid for an ad impression.

Perceptional biases (e.g., from eye-tracking studies) may also be considered.

A predetermined likelihood that a particular ad spot may be viewed may be updated using actual data to replace or modify model information (e.g., information about the browser actually being used, the actual user, actual user interaction with the Web page (e.g., scrolling, navigating back quickly), actual user interaction with the ad (e.g., hover, selection, etc.). For example, if the user quickly selects the “BACK” button of their browser, it might be inferred that the probability that the ad was seen or perceived should be reduced. As another example, if a user selects the ad, it might be inferred that the probability that the ad was seen or perceived should be one or about one.

The adjustment of a price may be a continuous price adjustment (e.g., by multiplying a starting price with a user perception probability estimate), a step-wise adjustment (e.g., reduce by half if ad spot is not initially viewable), etc. The price adjustment may use heuristics (e.g., if certain factors are present, use a first adjustment equation, if not and another factor is present use a second equation, if not and the other factor is not present, charge a flat price). One exemplary heuristic might be

if the ad spot is at the top of the document, charge
full price for an animation ad with audio,
80% for an image ad,
60% for large font color ad, and
50% for a normal text-only ad, and

otherwise,
if the Web page type has a scroll down rate of at least 75%, charge
   85% price for an animation ad with audio,
   70% for an image ad,
   55% for large font color ad, and
   40% for a normal text-only ad, and
if the Web page type has a scroll down rate between 25% and 75%, charge
   the price * the scroll down rate * (max [1, 10*historic selection rate of the ad spot]), and
if the Web page type has a scroll down rate 25% or less, charge 10%.

As can be appreciated by the foregoing example, there are many possible ways, consistent with the present invention, to use the user perception probability factors to adjust the cost.

Although many of the foregoing examples concerned probabilities or factors related to user perception of ads, embodiments consistent with the present invention may use probabilities or factors associated with any type of user sensing of ads.

### § 4.4 Examples of Operations

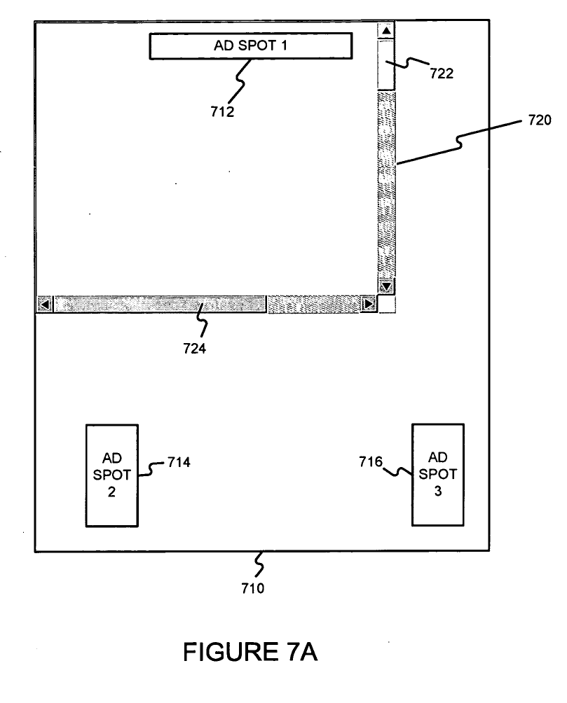

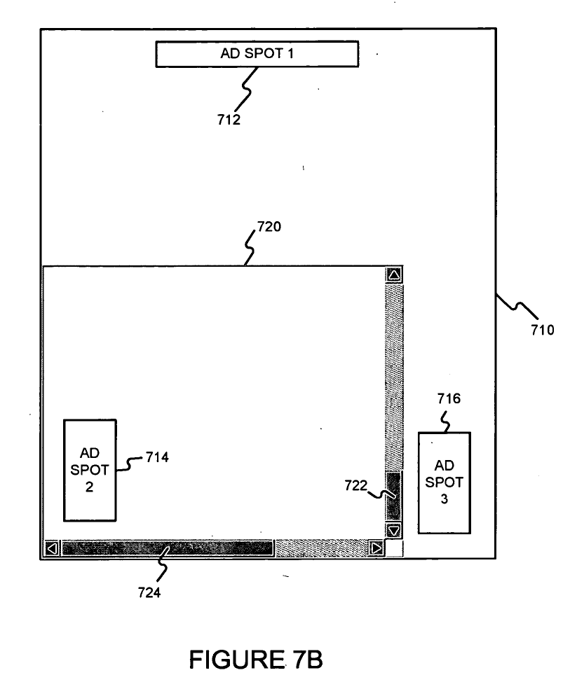

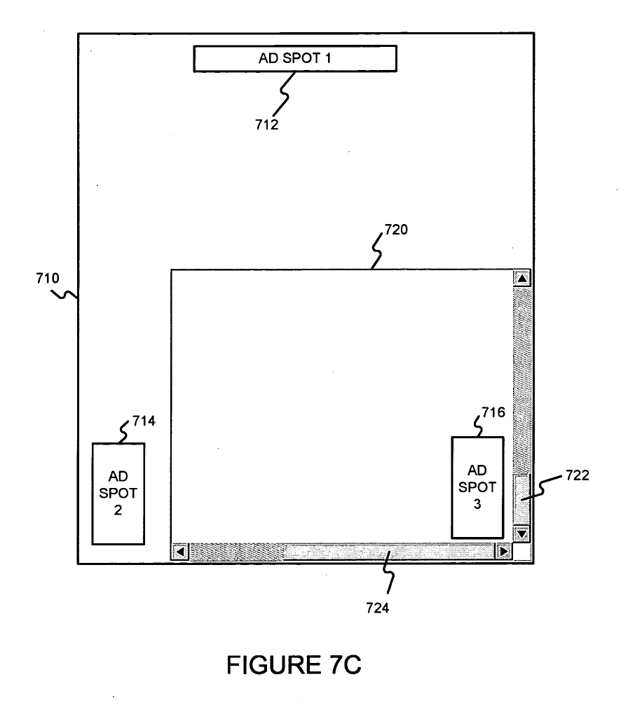

FIGS. 7A-7C illustrate how the per-impression costs of three (3) ads 712, 714, 716 served on a Web page 710 can be adjusted using an exemplary method consistent with the present invention. Assume that a baseline (or full-cost) price per impression on Web page 710 is $0.40.

Specifically assume a Web page 710, having three (3) ad spots 712, 714, 716 is loaded into a browser and viewed by a user. Referring to FIG. 7A, assume that the user can initially view only the portion of the Web page 710 within the window 720 (e.g., due to the resolution of the user's monitor, the length of the Web page, the browser being used, etc.). Notice that the window 720 includes up-down scroll bar 722 and left-right scroll bar 724. Therefore, it may be determined that ad 712 is very likely to be viewed or perceived by the user since it is rendered on an initially visible portion of the Web page 710. In this example, the price paid for an ad impression in ad spot 1 712 will be charged at full cost by the system. Thus, the cost for an impression in ad spot 1 712 will be $0.40 (perhaps subject to other price adjustments).

On the other hand, ad spot 2 714 and ad spot 3 716 are on portions of the Web page 710 outside of the window 720 and are therefore initially obscured. As shown in FIG. 7B, a user may scroll down using control bar 722. The new position of the window 720 allows ad spot 2 714 to become visible on the Web page 710. Assume that usage studies, the style of the Web page 710 and the browser used suggest that the ad spot 2 714 is estimated to be viewed at 65% of the time that ad spot 1 712 is viewed. In this example, the cost for an impression in ad spot 2 714 may be adjusted to $0.26 (=$0.40*65%) (perhaps subject to other price adjustments). Notice, however, that ad spot 3 716 is still not visible since it is still outside of the window 720.

As shown in FIG. 7C, a user may scroll right using control bar 724. The new position of the window 720 allows ad spot 3 716 to become visible on the Web page 710. Assume that usage studies, the style of the Web page 710 and the browser used suggest that the ad spot 3 716 is estimated to be viewed only 20% of the time that ad spot 1 712 is viewed. In this example, the cost for an impression in ad spot 3 716 may be adjusted $0.08 (=$0.40*20%) (perhaps subject to other price adjustments).

Naturally, other factors can be used to determine a likelihood that the user will view each of the ad spots. In the foregoing example, since ad spots 2 and 3 714, 716 are rendered on an initially obscured portion of the Web page 710, the price paid for ad impressions on spots 2 and 3 714, 716 are not charged at full price. Thus the system will charge a discounted price which may consider a likelihood that ads placed on ad spots 2 and 3 714, 716 will be viewed by the user.

Although not shown, a predetermined likelihood that a particular ad spot may be viewed may be updated using actual user interaction. Thus, for example, if a user scrolls down the Web page 710 as shown in FIG. 7B, the percentage associated with ad spot 2 714 may increase from 65% to 90%. As another example, if a user selects an ad in ad spot 3 716, the percentage associated with ad spot 3 716 may increase from 20% to 100%

### § 4.5 CONCLUSIONS

As can be appreciated from the foregoing, embodiments consistent with the present invention can be used to improve the pricing of ad impressions. Such embodiments may do so by adjusting prices using a likelihood that the ads will be viewed or perceived by end users, or using one or more user perception probability factors. This allows a large network of Websites with various ad spots to sell ads on a price-per-impression basis without the advertiser having to pay full price for placements which have a lower probability of being perceived, and without the need to separately negotiate and/or specify per impression prices for various ad spots or types of ad spots.

What is claimed is:

1. A computer-implemented method comprising:
a) accepting at least one factor on which a relative value of an ad impression with a document may be based; and
b) adjusting a price for the ad impression using the at least one factor.

2. The computer-implemented method of claim 1 wherein the act of adjusting a price to be paid for the ad impression using the at least one factor includes:
i) determining an estimate of a relative value of an ad impression, and
ii) adjusting the price to be paid for the ad impression using the estimate.

3. The computer-implemented method of claim 2 wherein the relative value of an ad impression is an indication of whether or not the ad will be perceived by a user.

4. The computer-implemented method of claim 1 wherein the at least one factor includes at least one of:
A) a location on a document where the ad is to be rendered.
B) whether or not the ad will be rendered on an initially visible portion of a rendered document,
C) a value of a format of a document, on which the ad is to be rendered,
D) a likelihood of browser scrolling,
E) a history of ad selections,
F) a history of ad mouse-overs,
G) a browser type on which the ad is to be rendered,
H) an absolute size of the ad,
I) a relative size of the ad,
J) a type of the ad,
K) a format of the ad,
L) a relationship of the ad with respect to content on the document with which the ad will be viewed,
M) survey data,
N) focus group data, and
O) view-through data.

5. The computer-implemented method of claim 1 wherein the at least one factor includes ad information.

6. The computer-implemented method of claim 5 wherein the ad information includes at least one of (A) whether the ad is a text-only ad, (B) whether the ad includes animation, (C) whether the ad includes audio, (E) whether the ad includes video, (F) whether the ad includes an image, (G) a size of the ad, (H) a font size of text in the ad, (I) colors of the ad, (J) selection information associated with the ad, and (K) selection information associated with a type of ad of which the ad is.

7. The computer-implemented method of claim 1 wherein the at least one factor includes client-device information.

8. The computer-implemented method of claim 7 wherein the client-device information includes at least one of (A) a browser type used by the client device, (B) a browser version used by the client device, (C) a display size of the client device, (D) a display resolution of the client device, (E) a speaker volume set by the client device, (F) whether the client device has a mute selected, and (G) user input means of the client device.

9. The computer-implemented method of claim 7 wherein the client-device information is inferred from market share information.

10. The computer-implemented method of claim 7 wherein the client-device information is inferred from survey information.

11. The computer-implemented method of claim 7 wherein the ad is rendered on a document, and
wherein the act of adjusting a price to be paid for the ad impression using the at least one factor includes:
i) determining an estimate of a relative value of an ad impression, by,
A) for each of a one or more Web browsers and one or more screen resolutions,
1) rendering the document per the rendering engine of the Web browser and the screen resolution, and
2) determining whether an ad is displayed within an initial on-screen portion of the document, and
B) determining the estimate from the one or more determinations of whether an ad is displayed within an initial on-screen portion of the document, and
ii) adjusting the price to be paid for the ad impression using the estimate.

12. The computer-implemented method of claim 1 wherein the at least one factor includes information about the document on which the ad is to be rendered.

13. The computer-implemented method of claim 12 wherein the document information includes at least one of a document type, a size of the document, size information of a document type of which the document is, a document age, a proportion of ad spots space to content space of the document, a proposition of ad spots space to content space of a document type of which the document is, past user dwell times of the document, past user dwell times of a document type of which the document is, past user scrolling of the document, past user scrolling of a document type of which the document is, past user interactions with ads on the document, and past user interactions with ads on a document type of which the document is.

14. The computer-implemented method of claim 12 wherein the document information includes a document type, and
wherein the act of adjusting a price to be paid for the ad impression using the at least one factor includes:
i) determining an estimate of a relative value of an ad impression, by,
A) accepting a user interaction model associated with the document type, and
B) determining the estimate using the user interaction model, and
ii) adjusting the price to be paid for the ad impression using the estimate.

15. The computer-implemented method of claim 14 wherein the user interaction model associated with the document type includes user actions that affect whether or not an ad spot will become visible.

16. The computer-implemented method of claim 14 wherein the user interaction model associated with the document type includes user scrolling information.

17. The computer-implemented method of claim 16 wherein the user scrolling information includes at least one of (A) scroll data collected from a sample of users using a special browser, and (B) scroll data collected from a sample of users using Javascript.

18. The computer-implemented method of claim 1 wherein the at least one factor includes document type information and wherein the document type information includes whether or not the document is one of (A) a business-to-business document, (B) a specialized industries document, (C) a business-to-consumer document, (D) an online retailers document, (E) a blogs document, (F) a journals document, (G) a browsers document, (H) a media players document, (I) a chat document, (J) a forum document, (K) a city guides document, (L) a local information, (M) a classified listings document, (N) a directories document, (O) a reference document, (P) a domain channel document, (Q) a download document, (R) a link collection document, (S) an enthusiast document, (T) a topical communities document, (U) an expert site document, (V) a FAQs document, (W) a technical information document, (X) an interactive games document, (Y) a home page document, (Z) a landing page document, (M) an image collection document, (BB) a login document, (CC) a site information document, (DD) a news content document, (EE) a niche vertical portal document, (FF) an online magazine document, (GG) a personals document, (HH) a portal document, (II) an ISP document, (JJ) a product review document, (KK) a consumer information document, (LL) a rich media document, (MM) a search document, (NN) a search results document, (OO) a social network document, and (PP) a spam document.

19. The computer-implemented method of claim 1 wherein the at least one factor includes ad spot information.

20. The computer-implemented method of claim 19 wherein the ad spot information includes at least one of (A) an absolute position of the ad spot, (B) a relative position of ad spot, (C) per-spot selection information, (D) per-spot mouse-over information, and (E) per-spot hover information.

21. The computer-implemented method of claim 19 wherein the ad spot information includes a relationship of the ad or ad spot with respect to content on the document with which the ad will be rendered, the relationship including at least one of (A) whether the ad will be rendered adjacent to the content, (B) whether the ad will be rendered separated from content, (C) whether the ad will be embedded within the content, (D) whether the ad will partially obscure the content, (E) whether the ad will totally obscure the content, (F) whether the ad will partially occlude the content, (G) whether the ad will totally occlude the content, (H) whether the ad will partially obscure other ads, (I) whether the ad will totally obscure other ads, (J) whether the ad will partially occlude other ads, (K) whether the ad will totally occlude other ads, (L) whether the ad will be partially obscured by the content, (M) whether the ad will be totally obscured by the content, (N) whether the ad will be partially occluded by the content, (O) whether the ad will be totally occluded by the content, (P) whether the ad will be partially obscured by other ads, (Q) whether the ad will be totally obscured other ads, (R) whether the ad be will partially occluded other ads, and (S) whether the ad will be totally occluded by other ads.

22. The computer-implemented method of claim 1 wherein the at least one factor is determined before the impression of the ad.

23. The computer-implemented method of claim 22 wherein the at least one factor is updated after the impression of the ad.

24. The computer-implemented method of claim 1 wherein the at least one factor is determined after the impression of the ad.

25. The computer-implemented method of claim 1 wherein the price is defined by an advertiser.

26. The computer-implemented method of claim 1 wherein the price is associated with a set of one or more serving constraints, and wherein the set of serving constraints has no other price for an impression of the ad.

27. The computer-implemented method of claim 1 wherein the at least one factor includes user information.

28. The computer-implemented method of claim 27 wherein the user information includes at least one of (A) user hover information, (B) user ad click information, (C) user dwell time information, (D) user scroll information, (E) user eye movement information, etc.), and (F) view-through data.

29. The computer-implemented method of claim 1 wherein the at least one factor includes at least one of survey data and focus group data.

30. Apparatus comprising:
a) means for accepting at least one factor on which a relative value of an ad impression with a document may be based; and
b) means for adjusting a price for the ad impression using the at least one factor.
